(19) United States
(12) Patent Application Publication
(10) Pub. No.: US 2011/0262787 A1
(43) Pub. Date: Oct. 27, 2011

(54) Electrochemical Cell with Reduced Magnetic Field Emission and Corresponding Devices

(76) Inventors: Hosein Maleki, Lawrenceville, GA (US); Jim Krause, Norcross, GA (US); Robert Zurek, Antioch, IL (US); Michael Frenzer, Palatine, IL (US); Jim Kim, Pleasant Prairie, WI (US)

(21) Appl. No.: 12/766,023

(22) Filed: Apr. 23, 2010

(51) Int. Cl. H01M 6/10; H01M 2/16

(52) U.S. Cl. 429/94; 429/247

(57) ABSTRACT

A battery pack having reduced magnetic emitted noise includes a housing having an electrode assembly (700) disposed therein. The electrode assembly (700) includes a cell stack comprising a cathode (701) and an anode (702) with a separator disposed therebetween. The cell stack of the electrode assembly (700) has a first end (705) and a second end (706). A first electrical conductor (703) coupled to the anode (702) at the first end (705) of the cell stack. A second electrical conductor (704) coupled to the cathode (701) at the first end (705) of the cell stack. During discharge, current (711,712) passes through the first electrical conductor (703) and second electrical conductor (704), and across the cathode (701) and anode (702), in substantially opposite directions at a substantially similar magnitude so as to reduce magnetic field noise generated by the electrode assembly (700).

### BACKGROUND

1. Technical Field

This invention relates generally to electrochemical cells, and more particularly to an electrochemical cell having a construction that delivers reduced magnetic field emissions when the electrochemical cell is in use.

2. Background Art

The world is rapidly becoming portable. As mobile telephones, personal digital assistants, portable computers, tablet computers, and the like become more popular, consumers are continually turning to portable and wireless devices for communication, entertainment, business, and information. Each of these devices owes its portability to a battery. The electrochemical cells operating within a battery not only allow these devices to slip the surly bounds of having to be tethered to a wall outlet, but provide a reliable, light weight power source that can be recharged again and again.

Electrochemical cells, including alkaline based cells, nickel based cells, and lithium based cells, are generally manufactured by taking two electrode layers and stacking them together, with each layer being physically separate from the other. A common way to manufacture the electrochemical cells used in the batteries is known as the “jellyroll” technique, where the inner parts of the cell are rolled up and placed inside an aluminum or steel can, thereby resembling an old-fashioned jellyroll cake. Aluminum is frequently the preferred metal for the can due to its light weight and favorable thermal properties, although steel is used as well.

The primary job for the electrochemical cell is to selectively store and deliver energy.

Energy is stored when the cell is being charged. This stored energy can then be delivered to an electronic device during the discharge stage. Advances in electrode materials and cell constructions provide consumers with small batteries capable of storing large amounts of energy in small, lightweight packages.

Magnetic field emissions of an electrochemical cell are generally not a design consideration. By way of example, when an electrochemical cell is being used to power a typical electronic device, the magnetic field emissions therefrom may not be significant enough to affect the operation of that device. However, in some applications, the magnetic emission of an electrochemical cell can be a design issue. For example, in sensitive devices like hearing aids, magnetic field emissions can compromise performance or reliability by affecting the operation of the acoustic elements within the hearing aid.

There is thus a need for an electrochemical cell having reduced magnetic emission.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a cross-sectional side view of a typical prior art electrode layer assembly.

FIG. 2 illustrates a prior art stack of electrodes assembled in the jellyroll configuration so as to make a rechargeable cell.

FIG. 3 illustrates a cut away, cross sectional view of a prior art jellyroll inserted into a cylindrical metal can.

FIG. 4 illustrates one embodiment of a prior art cell construction suitable for use in a battery.

FIG. 5 illustrates an unrolled prior art cell construction illustrating typical currents and corresponding magnetic fields.

FIG. 6 illustrates graphically measured magnetic field shapes corresponding to the construction of FIG. 4 when supplying power to load simulating a transceiver in a Global System for Mobile Communications (GSM) communication application.

FIG. 7 illustrates one embodiment of an unrolled cell construction illustrating typical currents and corresponding magnetic fields when configured in accordance with embodiments of the invention.

FIG. 8 illustrates graphically measured magnetic field shapes corresponding to the construction of FIG. 6 when supplying power to load simulating a transceiver in a GSM communication application.

FIG. 9 illustrates another embodiment of an unrolled cell construction illustrating typical currents and corresponding magnetic fields when configured with other embodiments of the invention.

FIG. 10 illustrates graphically measured magnetic field shapes corresponding to the construction of FIG. 9 when supplying power to load simulating a transceiver in a GSM communication application.

FIG. 11 illustrates an electrochemically active layer configured in accordance with one embodiment of the invention having magnetically permeable materials disposed therein.

FIG. 12 illustrates one construction of an electrochemical cell configured in accordance with one embodiment of the invention, wherein the electrode layers are coated with a magnetically permeable material.

FIG. 13 illustrates one construction of an electrochemical battery configured in accordance with one embodiment of the invention, wherein an external can is coated with magnetically permeable materials.

FIG. 14 illustrates one construction of an electrochemical cell and header assembly having tabs and conductors configured with one embodiment of the invention.

FIG. 15 illustrates one construction of an electrochemical cell and header assembly having tabs and conductors configured with one embodiment of the invention.

FIG. 16 illustrates one construction of an electrochemical cell and header assembly having tabs and conductors configured with one embodiment of the invention.

FIG. 17 illustrates one construction of an electrochemical cell and header assembly having tabs and conductors configured with one embodiment of the invention.

FIG. 18 illustrates a stacked construction of an electrochemical cell configured in accordance with one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide an electrochemical cell and corresponding battery configured to deliver reduced magnetic field emissions. In one embodiment, an electrochemical cell, such as a lithium-ion or lithium polymer cell, is configured with electrical tab connections to the cathode and anode being placed on the same end of a cell stack, such that currents flowing in the anode tend to be opposite in direction, but substantially similar in magnitude, from currents flowing in the cathode throughout the electrochemical cell. As such, magnetic fields generated by the cathode layer tend to cancel magnetic fields generated by the anode layer, thereby reducing overall magnetic emissions.

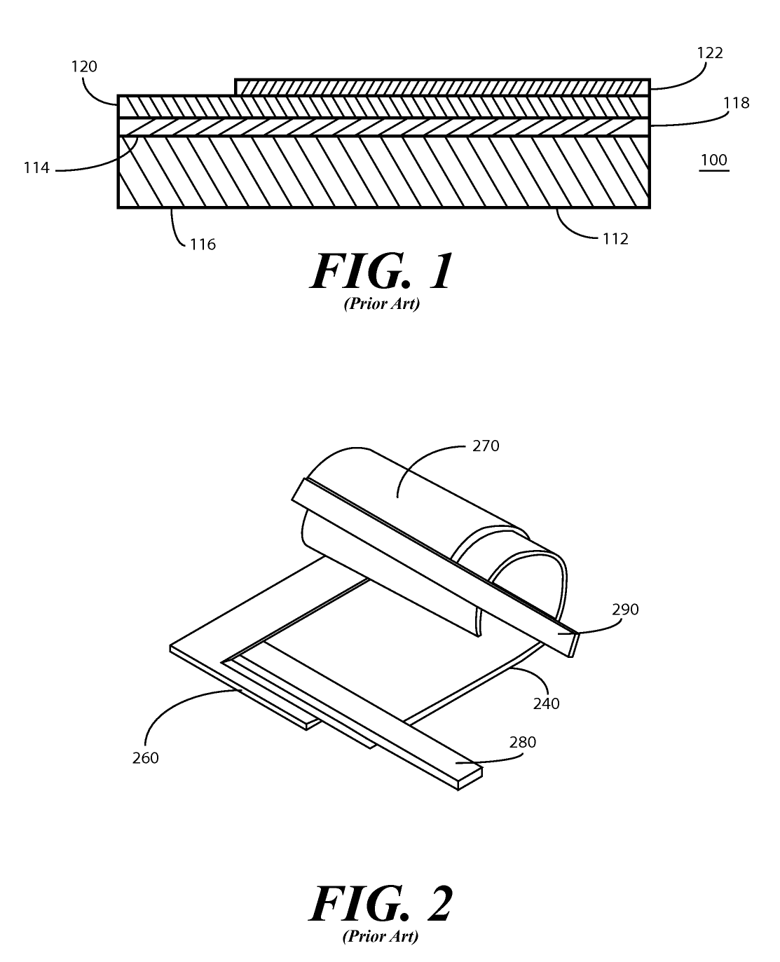

Electrochemical cells are generally made from a positive electrode (cathode), a negative electrode (anode), and a separator that prevents these two electrodes from touching. While the separator physically separates the cathode and anode, the separator permits ions to pass therethrough. Referring now to FIG. 1, illustrated therein is a cross-sectional side view of a typical electrode layer assembly found in an electrochemical cell.

The electrode 100 includes a separator 112 having a top and bottom 114 and 116. Disposed on the top 114 of the separator 112 is a first layer 118 of an electrochemically active material. For example, in a nickel metal hydride battery, the first layer 118 may be a layer of a metal hydride charge storage material as is known in the art. Alternatively, the first layer 118 may be lithium or a lithium intercalation material as is commonly employed in lithium batteries.

Disposed atop first layer 118, is a current collecting layer 120. The current collecting layer may be fabricated of any of a number of metals or alloys known in the art. Examples of such metals or allowys include, for example, nickel, aluminum, copper, steel, nickel plated steel, magnesium doped aluminum, and so forth. Disposed atop the current collection layer 120 is a second layer 122 of electrochemically active material.

The electrochemical cell stores and delivers energy by transferring ions between electrodes through a separator. For example, during discharge, an electrochemical reaction occurs between electrodes. This electrochemical reaction results in ion transfer through the separator, and causes electrons to collect at the negative terminal of the cell. When connected to a load, such as an electronic device, the electrons flow from the negative pole through the circuitry in the load to the positive terminal of the cell. (This is shown in circuit diagrams as current flowing from the cathode to the anode.) When the electrochemical cell is charged, the opposite process occurs. Thus, to power electronic devices, these electrons must be delivered from the cell to the electronic device. This is generally accomplished by coupling conductors, such as conductive foil strips, sometimes referred to colloquially as “tabs” to the various layers. Such tabs are shown in FIG. 2.

Referring now to FIG. 2, illustrated therein is stack of electrodes like that in FIG. 1 assembled in the jellyroll configuration so as to make a rechargeable cell. In FIG. 2, two electrodes 240 and 260 are provided as described above. Electrode 240 is fabricated with a layer of, for example, electrochemically active negative electrode material while electrode 260 is fabricated with a layer of electrochemically active positive electrode material. Note that either electrode 240,260 can be electrochemically active when the cell is initially constructed.

A first tab 280 is coupled to one electrode 240, while a second tab 290 is coupled to another electrode 260. These tabs 280,290 can be coupled to the current collectors of each electrode 240,260.

The electrodes 240 and 260 are arranged in stacked relationship, with the tabs 280,290 being disposed on opposite edges of the stack. Thereafter, the stack is rolled into a roll 270 for a subsequent insertion into an electrochemical cell can. The cans are generally oval, rectangular, or circular in cross section with a single opening and a lid. This is similar to the common trashcan.

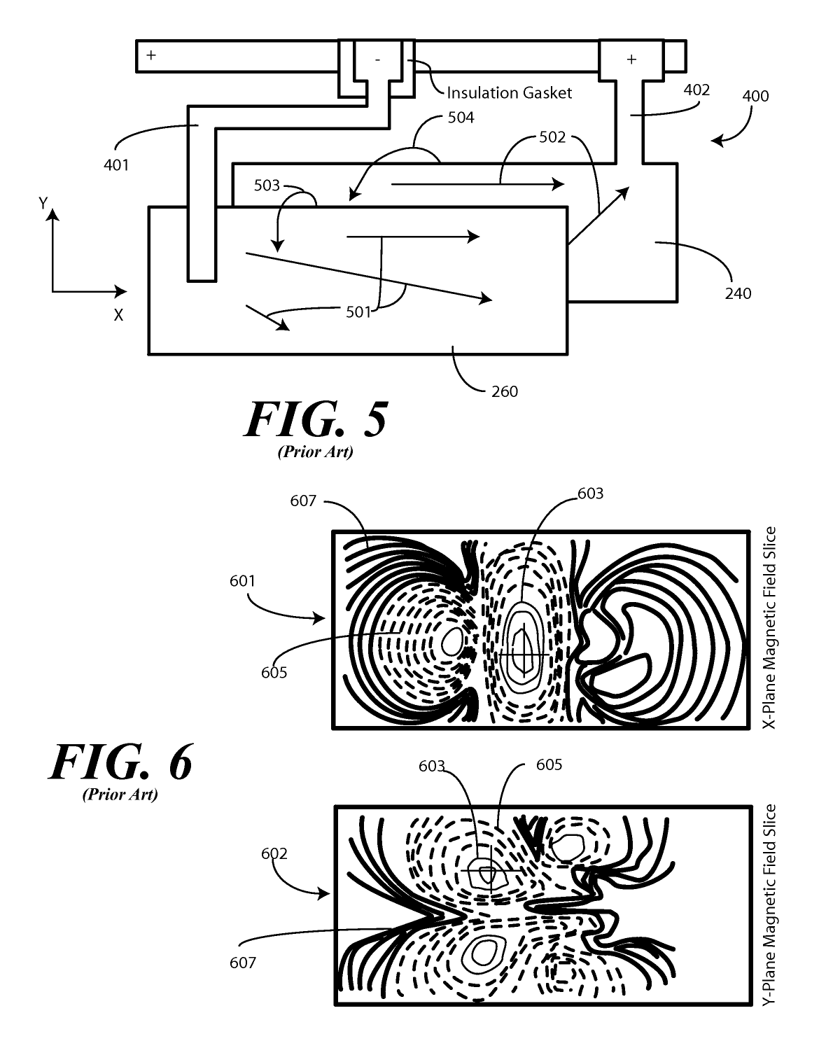

Prior art cells such as that shown in FIG. 2 are manufactured with the tabs 280,290 disposed on opposite ends of the electrodes 240,260. This results in the two electrodes 240,260 carrying current in substantially the same direction when active. This co-directional current creates a large toroidal magnetic field in accordance with the right hand rule, as the fields generated by each electrode 240,260 are additive. This will be more clearly shown in FIG. 5.

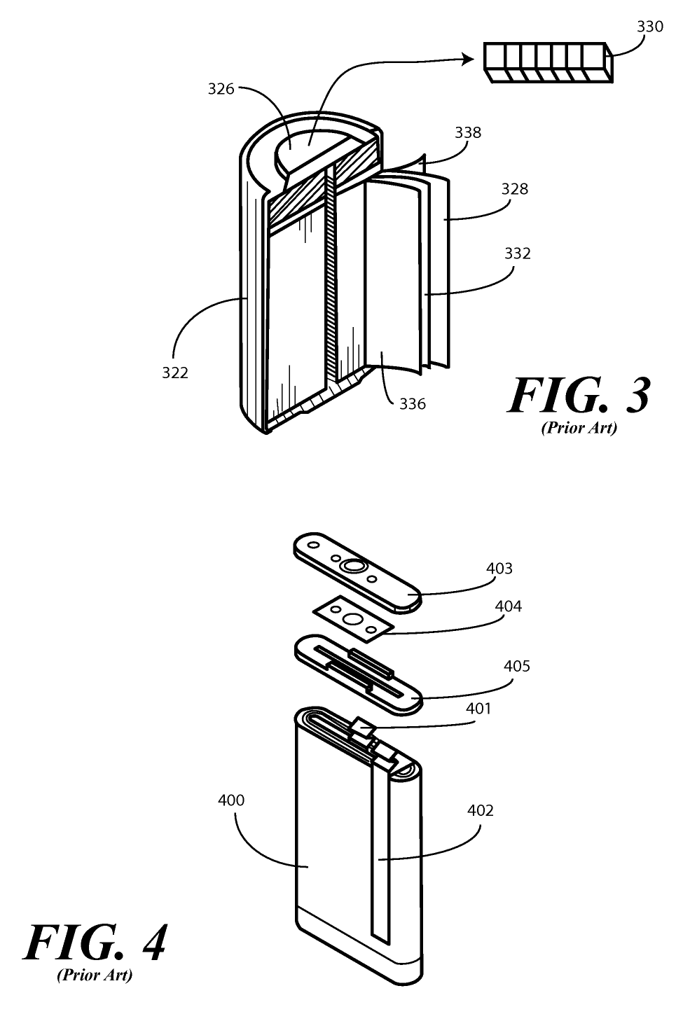

Once the jellyroll is complete, it is inserted into a metal can 322 as shown in FIG. 3. In this cylindrical configuration, the metal can 322 includes a metal connector 326 that may serve as the cathode terminal of the resulting battery. The metal can 322 itself often serves as the anode terminal. The tabs (280,290) are coupled to the metal connector 326 and metal can 322 in this configuration. In alternate configurations, such as rectangular or oval shaped batteries, the tabs (280,290) can be coupled to a connector assembly 330 rather than metal connectors on the can.

In either scenario, looking to the jellyroll, the various layers can be seen: separator 332, first electrode 328, and second electrode 336. Depending upon the construction, a current collector 338 or grid may be added to the device if desired. The current collector 338 can be formed from a metal or alloy such as copper, gold, iron, manganese, nickel, platinum, silver, tantalum, titanium, aluminum, magnesium doped aluminum, copper based alloys, or zinc.

Turning now to FIG. 4, illustrated therein is a prior art jellyroll 400 with tabs 401,402 configured as in FIG. 2. The jellyroll 400 will be inserted into a metal can as previously described. The prior art assembly of FIG. 4 includes a first metal connector 403 that serves as the external cathode and a tab 404 for coupling the first metal connector 403 to the first tab 401. An insulator 405 is provided to isolate the first metal connector 403 from the second tab 402. Flat, top insulators, at one end of the jellyroll 400, are known in the art as recited in U.S. Pat. No. 6,317,335 to Zayatz.

The jellyroll 400 of FIG. 4 creates a relatively large amount of magnetic field noise in operation. This noise is measured in dB A/m, and increases with increasing current. Further, when the current is pulsed, as is the case when a cell is servicing a GSM device such as a mobile telephone, the noise is exacerbated.

Turning now to FIG. 5, illustrated therein is the jellyroll 400 of FIG. 4 in its unwound form. This unwound illustration is useful in showing how this construction generates magnetic field noise. When under load, anode currents flow away from the tab 401 coupled to the electrode 260 that serves as the anode. The anode current 501 flows generally left to right in the view of FIG. 5 in accordance with a gradient. Since the tab 401 is coupled to the upper portion of the anode, the anode current 501 will tend to flow from an upper left portion of the anode to a lower right portion of the anode.

When this occurs, a first magnetic field 503 will be generated in accordance with the right hand rule. The first magnetic field 503 will be largest near the tab 401, and will become smaller away from the tab 401 as ions pass through the separator, in an electrolyte, to the electrode 240 serving as the cathode.

Turning to the electrode 240 serving as the cathode, the tab 402 is connected to the cathode on the right side. When under load, cathode currents 502 flow toward the tab 402, which is left to right in the view of FIG. 5 in accordance with a charge gradient. The cathode current 502 flows generally left to right in the view of FIG. 5. In the illustrative embodiment of FIG. 5, the cathode current 502 tends to flow from a lower left portion of the cathode to an upper right portion of the cathode.

When this occurs, a second magnetic field 504 will be generated in accordance with the right hand rule. The second magnetic field 504 will be largest near the tab 402, and smaller away from the tab 402 as electrons pass through the separator, through the electrolyte, from the electrode 260 serving as the anode.

As shown in FIG. 5, due to the cell construction, the first magnetic field 503 and second magnetic field 504 are additive. While the anode current 501 and cathode current 502 are shown as arrows, when the cell is servicing a time-varying load, such as a GSM transceiver in a mobile telephone, the resulting alternating magnetic field manifests itself as extraneous noise. This noise can produce a large base band magnetic field.

Turning now to FIG. 6, illustrated therein is a plot of a slice through the magnetic fields (503,504) generated by the construction of FIG. 5 when delivering current to a test GSM load. Plot 601 shows a slice of the measured magnetic field in the X-direction, while plot 602 shows a slice of the measured magnetic field in the Y-direction. Lines 603 show the most intense fields, while lines 607 show the least intense fields. Lines 605 show medium intensity fields.

Each measurement in plot 601 and 602 is referenced to 0 dB, which is 1 ampere per meter. In plot 601, the maximum field is 8.49 dB, while the minimum field is −29.75 dB. In plot 602, the maximum field is 4.07 dB, while the minimum field is −30.23 dB.

As can be seen, under a time varying load current, the electrode windings of the jellyroll (400) and tabs (401,402), together, create loops of electrical current that generate large contours of base-band magnetic field noise. Where the jellyroll is incorporated into a battery having a safety circuit, the magnetic field noise may further be exacerbated with the design of the accompanying circuit board assembly. In hearing aids operating in telecoil modes, magnetic field emissions of a battery can degrade the signal-to-noise ratios within the hearing aid.

Embodiments of the present invention provide cell and battery constructs that provide significantly reduced magnetic field noise. In one embodiment, a cell construction includes positioning the tabs coupled to the anode and cathode physically on the same end of a stack prior to rolling the jellyroll. Where properly placed, currents flowing in the anode and cathode can be distributed such that they each substantially move in opposite directions at substantially similar magnitudes, thereby mitigating same direction current flow. In some embodiments, the tabs can be placed physically atop each other to prevent additional loops from being formed by the tabs connecting the cell to a connector terminal or safety circuitry.

In some embodiments, multiple tabs are used with each electrode. For example two tabs may be placed on opposite ends of each electrode, with each tab connecting to lead to an external connection. In some embodiments, high permeability magnetic materials are incorporated within cell components, such as the tabs, the electrodes, or the can. In some embodiments, internal walls of the can may be coated with high permeability magnetic materials. Further, in some embodiments the electrodes themselves can be coated with high permeability magnetic materials. In some embodiments conductive traces within the cells can be routed such that their magnetic fields cancel. In some embodiments, magnetic cancellation coils can be added to the battery structure or can. These coils work to cancel the magnetic field of the cell and tabs. Each of these will be explained in more detail in conjunction with the following figures.

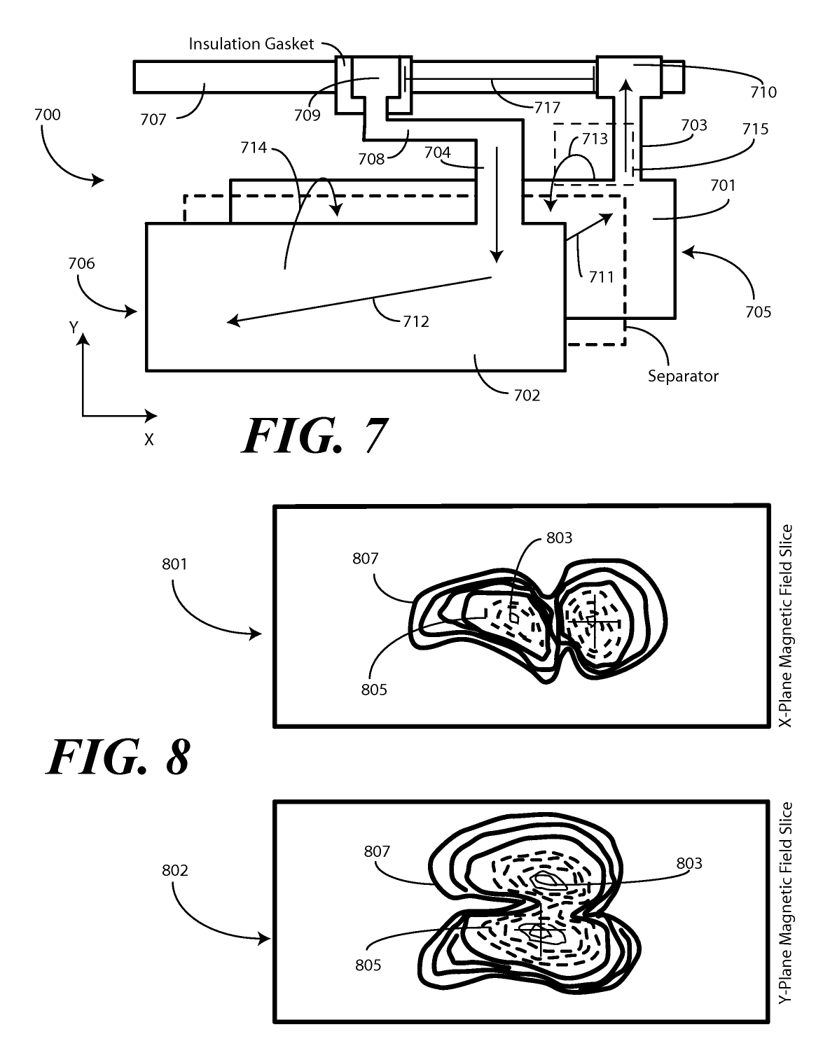

Turning now to FIG. 7, illustrated therein is one embodiment of an electrode assembly 700, suitable for winding into a jellyroll, that is configured to significantly reduce emitted magnetic field noise when compared to prior art constructions. The electrode assembly 700 of FIG. 7 includes a cell stack having a cathode 701 and anode 702. When layered atop each other, a separator (not shown) is placed therebetween to permit electrons to pass to and from the cathode 701 and anode 702 during charge and discharge.

A first electrical conductor 703, shown in FIG. 7 as a conductive tab made from foil aluminum or another electrically conductive material, is coupled to the cathode 701. As shown in FIG. 7, the first electrical conductor 703 is coupled at a first end 705 of the cell stack. The cell stack includes a first end 705 and a second end 706.

A second electrical conductor 704, also shown in FIG. 7 as a conductive tab made from foil aluminum or copper or other similar material, is coupled to the anode 702. As shown in FIG. 7, the second electrical conductor 704 is coupled to the first end 705 of the cell stack just as is the first electrical conductor 703. Accordingly, both the first electrical conductor 703 and second electrical conductor 704 are coupled to the cathode 701 and anode 702, respectively, at the same end of the cell stack. To ensure shorting does not occur at the header 707, a bridge member 708 couples the second electrical conductor 704 to its contact 709 on the header 707, thereby providing a predetermined amount of physical separation between the contact 710 connected to the first electrical conductor 703 and the second electrical conductor 704 along the header 707.

When under load, cathode currents 711 flow toward the first electrical conductor 703, which is left to right in the view of FIG. 7. The cathode currents 711 flow in accordance with a gradient that depends upon the cathode construct and the load. The cathode current 711 flows generally left to right in the view of FIG. 7. In the illustrative embodiment of FIG. 7, the cathode current 711 will tend to flow from a lower left portion of the cathode to an upper right portion of the cathode 701.

When this occurs, a first magnetic field 713 will be generated in accordance with the right hand rule. The first magnetic field 713 will be largest near the first electrical conductor 703, and smaller away from the first electrical conductor 703 as electrons pass through the separator to from the anode 702.

At the same time, anode currents 712 in the embodiment of FIG. 7 flow away from the second electrical conductor 704 that is coupled to the anode 702. Accordingly, the anode current 712 flows generally right to left in the view of FIG. 7 in accordance with a gradient function. Since the second electrical conductor 704 is coupled to the upper portion of the anode 702, the anode current 712 will tend to flow from an upper right portion of the anode 702 to a lower left portion of the anode 702.

When this occurs, a second magnetic field 714 will be generated in accordance with the right hand rule. The second magnetic field 714 will be largest near the second electrical conductor 704, and will become smaller away from the second electrical conductor 704 as electrons pass through the separator to the cathode 701.

As shown in FIG. 7, due to the cell construction, the first magnetic field 713 and second magnetic field 714 tend to cancel each other. By varying the size and materials of each electrode, along with the placement of the first electrical conductor 703 along the cathode 701 and placement of the second electrical conductor 704 along the anode 702, a designer may “tune” the cell stack to minimize the resulting magnetic field noise for a particular battery configuration. For example, if a designer is designing a high-capacity, rectangular battery, the designer may vary the exact placement of each of the first electrical conductor 703 and second electrical conductor 704 to minimize the resultant magnetic field noise for that physical configuration.

In the illustrative embodiment of FIG. 7, the first electrical conductor 703 and the second electrical conductor 704 are disposed atop each other at the first end 705 of the cell stack. Note that this is but one embodiment that is used in FIG. 7 for explanatory purposes. It will be clear to those of ordinary skill in the art having the benefit of this disclosure that embodiments of the invention are not so limited. For example, instead of being disposed atop each other, the first electrical conductor 703 and second electrical conductor 704 could be separated along the header 707. Where they are configured as in FIG. 7, to prevent shorting issues, an electrical insulation layer 715 may be disposed therebetween. In this configuration, during discharge, current passes across adjacent areas of the cathode 701 and anode 702 in substantially opposite directions. The current also passes along adjacent areas of the cathode 701 and anode 702 in substantially equal magnitude. Similarly, current passes through the first electrical conductor 703 and second electrical conductor 704 in substantially opposite directions so as to reduce the overall magnetic field noise generated by the electrode assembly.

Using the tuning process described above, the designer is able to greatly reduce the noise generated by the cell—not just by controlling the direction of the current flowing through the cathode 701, anode 702, first electrical conductor 703 and second electrical conductor 704, but also the relative magnitudes as well. By varying the placement of the first electrical conductor 703 and second electrical conductor, the designer may achieve currents flowing therein that are both opposite in direction and of nearly equal magnitudes. As the currents flowing in the cathode 701 and anode 702 vary with a gradient function, altering the materials, geometry, and size of the cathode 701 and anode 702, as well as the placement, geometry, and size of the first electrical conductor 703 and second electrical conductor 704, the designer can achieve opposite currents of substantially equivalent magnitudes on adjacent portions of the cathode 701 and anode 702.

Illustrating by way of example, simply placing the first electrical conductor 703 and second electrical conductor 704 on the first end 705 of the cell stack can achieve currents 711,712 flowing in opposite direction. However, by varying the placement of the first electrical conductor 703 and second electrical conductor 704 in accordance with embodiments of the present invention, the designer can achieve opposite and substantially equal currents over most of the length of the anode 702 and cathode 701.

Turning now to FIG. 8, illustrated therein is a plot of a slice through the magnetic field generated by the construction of FIG. 7 when delivering current to a test GSM load. Plot 801 shows the measured magnetic field in the X-direction, while plot 802 shows the measured magnetic field in the Y-direction. Lines 803 show the most intense fields, while lines 807 show the least intense fields. Lines 805 show medium intensity fields.

As with FIG. 6, each measurement in plot 801 and plot 802 is referenced to 0 db, which is 1 ampere per meter. In plot 801, the maximum field is −4.81 dB, while the minimum field is −32.91 dB. In plot 802, the maximum field is −1.06 dB, while the minimum field is −30.86 dB. When comparing FIG. 8 to FIG. 6, a dramatic decrease in measured magnetic field noise can be seen. In the X-plane, a decrease in over 12 dB has occurred in the maximum magnetic field. In the Y-plane, a decrease of nearly 5 dB has occurred.

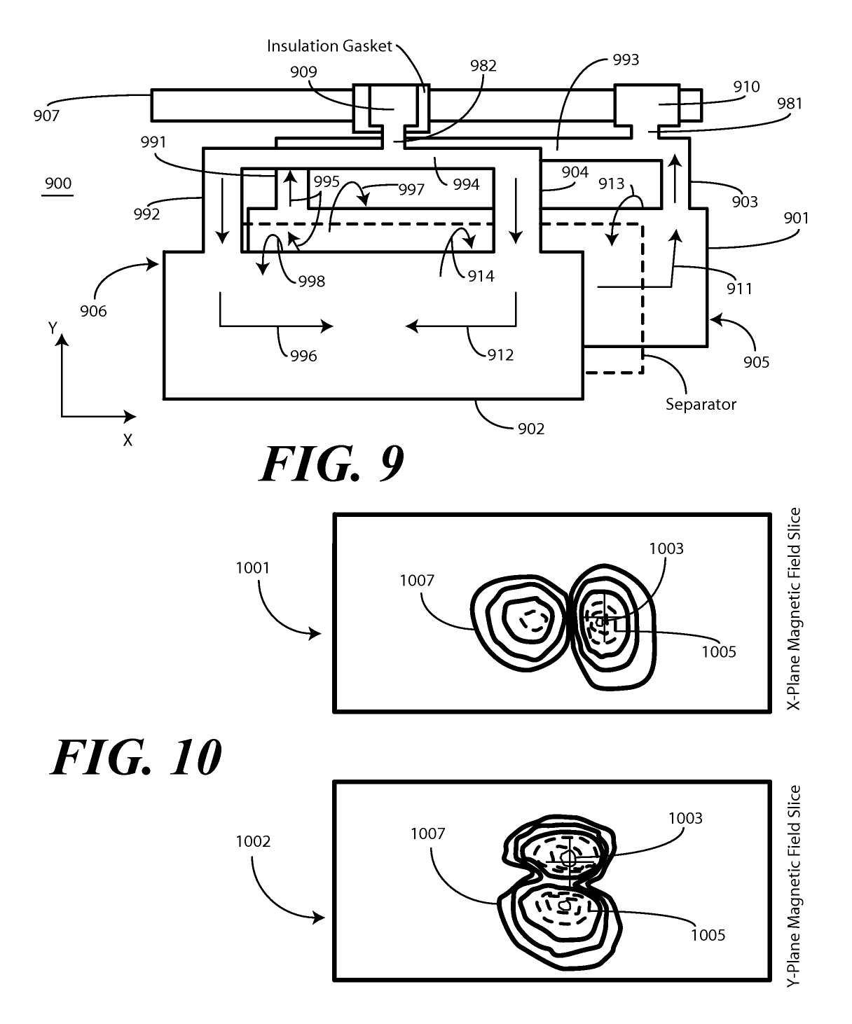

Turning now to FIG. 9, illustrated therein is another embodiment of an electrode assembly 900, suitable for winding into a jellyroll and for placement within a can or housing, that is configured to significantly reduce emitted magnetic field noise when compared to prior art constructions. The electrode assembly 900 of FIG. 9 includes a cell stack having a cathode 901 and anode 902. When layered atop each other, a separator (not shown) is placed therebetween to permit ions to pass to and from the cathode 901 and anode 902 during charge and discharge, respectively.

A first electrical conductor 903 is coupled to the cathode 901. As shown in FIG. 9, the first electrical conductor 903 is coupled at a first end 905 of the cell stack. The cell stack includes a first end 905 and a second end 906.

A second electrical conductor 904 is coupled to the anode 902. As shown in FIG. 9, the second electrical conductor 904 is coupled to the first end 905 of the cell stack just as is the first electrical conductor 903. Accordingly, both the first electrical conductor 903 and second electrical conductor 904 are coupled to the cathode 901 and anode 902, respectively, at the same end of the cell stack.

A third electrical conductor 991 is coupled to the cathode 901 at the second end 906 of the cell stack. A first bridge member 993 couples the third electrical conductor 991 to the first electrical conductor 903.

A fourth electrical conductor 992 is coupled to the anode 902 at the second end 906 of the cell stack. A second bridge member 994 couples the fourth electrical conductor 992 and the second electrical conductor 904.

In the illustrative embodiment of FIG. 9, a fifth electrical conductor 981 connects the first bridge member 993 to a contact 910 on the header 907. Similarly, a sixth electrical conductor 982 couples the second bridge member 994 to a contact 909 on the header 907.

In one embodiment, the first electrical conductor 903 and second electrical conductor 904 are disposed atop each other with an optional layer of electrically insulating material disposed therebetween. Similarly, the third electrical conductor 991 and fourth electrical conductor 992 can be disposed atop each other with an optional layer of electrically insulating material disposed therebetween. Further, the first bridge member 993 can be disposed atop the second bridge member 994 with an optional layer of electrically insulating material disposed therebetween. In such a configuration, the currents flowing in the anode 902 and cathode 901, respectively, will be substantially of the same magnitude and in opposite direction, thereby mitigating any resulting magnetic field noise emission. Note that this “everything atop its counterpart” configuration is but one embodiment, which is used in FIG. 9 for explanatory purposes. It will be clear to those of ordinary skill in the art having the benefit of this disclosure that embodiments of the invention are not so limited. For example, instead of each component being disposed atop its counterpart from the other electrode small amounts of separation may be provided, for example, to eliminate the need for insulating materials.

When under load, cathode currents 911,995 flow toward the first electrical conductor 903 and fourth electrical conductor 992, respectively, which is left to right for cathode current 911 and right to left for cathode current 995 in the view of FIG. 9. Note that, all else being equal, these currents 911,995 will be approximately half of the currents flowing through the same conductors in the embodiment of FIG. 7, thereby further reducing the correspondingly generated magnetic fields about these conductors. (The same is true with the anode.) The cathode currents 911,995 flow in accordance with a gradient that depends upon the cathode construct and the load. The cathode currents 911,995 flow generally from a central portion of the cathode 901, upward and outward in the view of FIG. 9. As with the conductor currents, since the cathode currents 911,995 are flowing through multiple conductors 901,991, the peak current densities flowing along the cathode will be approximately half that of FIG. 7, thereby further reducing peak magnetic field emissions. (The same is true with the anode.)

When this occurs, first magnetic fields 913,997 will be generated in accordance with the right hand rule. The first magnetic fields 913,997 will be largest near the first electrical conductor 903 and third electrical conductor 991, and smaller towards the center of the cathode 901.

At the same time, anode currents 912,996 in the embodiment of FIG. 9 flow away from the second electrical conductor 904 and fourth electrical conductor 992, respectively. Accordingly, anode current 912 flows generally right to left in the view of FIG. 9 in accordance with a gradient function, while anode current 996 flows left to right. In the illustrative embodiment of FIG. 9, the anode currents 912,996 will tend to flow from upper corner portions of the anode 902 to lower central portions.

When this occurs, second magnetic fields 914,998 will be generated in accordance with the right hand rule. The second magnetic fields 914,998 will be largest near the second electrical conductor 904 and fourth electrical conductor 992, and will become smaller toward central portions of the anode 902 as electrons pass through the separator to the cathode 901.

As shown in FIG. 9, due to the cell construction and placement of the electrical conductors 903,904,991,992 and bridge members 993,994, the first magnetic fields 913,997 and second magnetic fields 914,998 tend to cancel each other. Further, the anode currents 912,996 and cathode currents 911,995 tend to be in opposite direction and of substantially similar magnitude so as to reduce the overall magnetic field noise generated by the electrode assembly. Also, the currents in conductors 903 and 991 tend to be in opposite direction and of substantially similar magnitude to the currents in conductors 904 and 992 so as to reduce the overall magnetic noise generated by the conductors. The same holds for bridge members 993 and 994.

Turning now to FIG. 10, illustrated therein is a plot of a slice through the magnetic field generated by the construction of FIG. 9 when delivering current to a test GSM load. Plot 1001 shows the measured magnetic field in the X-direction, while plot 1002 shows the measured magnetic field in the Y-direction. Lines 1003 show the most intense fields, while lines 1007 show the least intense fields. Lines 1005 show medium intensity fields.

As with FIGS. 6 and 8, each measurement in plot 1001 and plot 1002 is referenced to 0 db, which is 1 ampere per meter. In plot 1001, the maximum field is −7.39 dB, while the minimum field is −33.42 dB. In plot 1002, the maximum field is −5.97 dB, while the minimum field is −30.49 dB. When comparing FIG. 10 to FIG. 6, a dramatic decrease in measured magnetic field noise can be seen. In the X-plane, a decrease in nearly 15 dB has occurred in the maximum magnetic field. In the Y-plane, a decrease of more than 9 dB has occurred.

As shown above, placement of tabs and arrangement of the cell stack construction can greatly reduce the magnetic field noise emitted by the resulting cell when wound into a jellyroll and placed within a housing, such as the can shown in FIG. 4. However, in accordance with other embodiments of the present invention, there are additional steps that a designer may take to further mitigate the magnetic field noise.

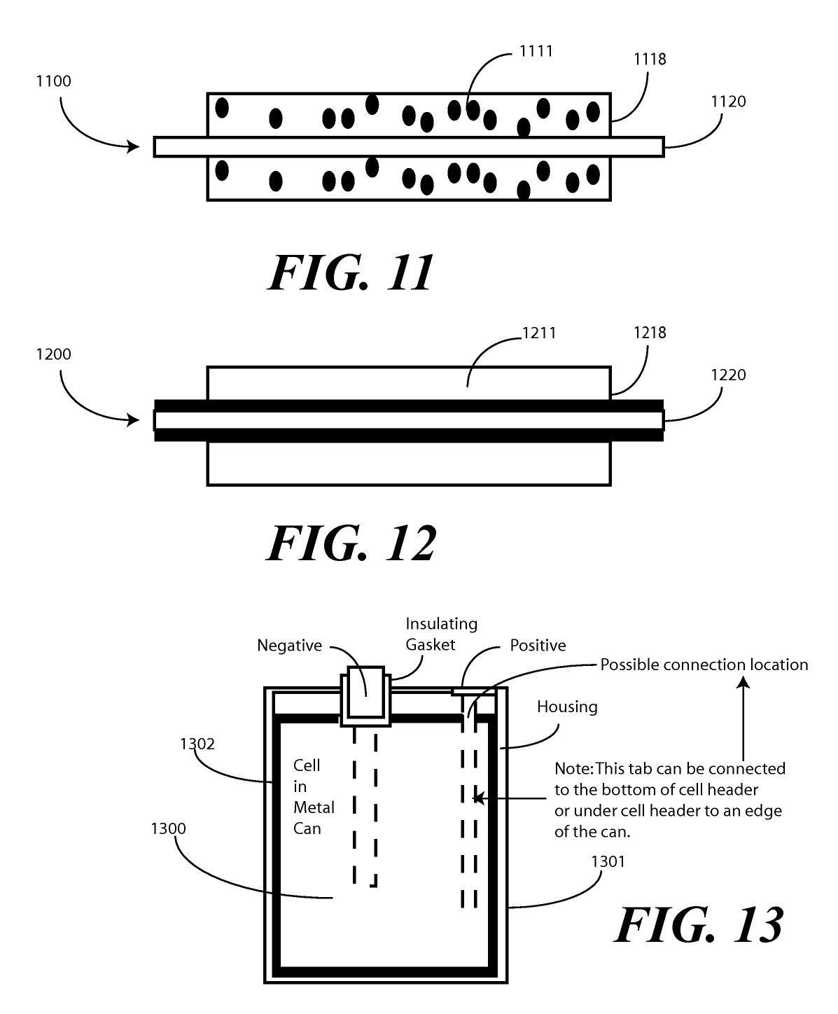

Turning now to FIG. 11, illustrated therein is a sectional view of one electrode 1100 suitable for use in an electrode assembly configured in accordance with embodiments of the present invention. In FIG. 11, the electrode 1100 includes layer 1118 of electrochemically active material, such as a layer of metal hydride charge storage material or a lithium intercalation material. Disposed beneath this layer 1118 is a current collecting layer 1120. The current collecting layer 1120 may be fabricated of any of a number of metals or alloys, including nickel, copper, stainless steel, silver, aluminum, nickel plated steel, magnesium doped aluminum, copper based alloys, or titanium.

Each layer 1118,1122 of electrochemically active material has been filled or impregnated with particles of high magnetic permeability material 1111. Examples of high magnetic permeability materials 1111 include nickel, cobalt, manganese, chromium and iron. By impregnating the electrochemically active material with high magnetic permeability materials 1111, the overall magnetic field noise can be further reduced.

Turning now to FIG. 12, illustrated therein is a sectional view of another electrode 1200 suitable for use in an electrode assembly configured in accordance with embodiments of the present invention. In FIG. 12, the electrode 1200 includes layer 1218 of electrochemically active material. Disposed beneath this layer 1218 is a current collecting layer 1220.

In FIG. 12, the current collecting layer 1220 has been coated with layers of high magnetic permeability material 1211. By coating the current collecting layer 1220 with high magnetic permeability materials 1211, the overall magnetic field noise can be further reduced. Of course, a combination of the embodiment of FIG. 11, employing high permeability impregnation, and the embodiment of FIG. 12 can also be constructed in accordance with embodiments of the present invention.

Turning now to FIG. 13, illustrated therein is one embodiment of an electrode assembly 1300 configured in accordance with embodiments of the present invention disposed in a housing 1301, which for illustration purposes is configured as a can. To further reduce the emitted magnetic field noise, in this illustrative embodiment, the housing 1301 has been coated with a high magnetic permeability material 1302. While the internal walls of the housing 1301 are coated in the illustrative embodiment of FIG. 13, it will be obvious to those of ordinary skill in the art having the benefit of this disclosure that embodiments of the invention are not so limited. For example, the outer surfaces of the housing 1301 could equally be coated with the high magnetic permeability material 1302. Further, both the inner and outer surfaces of the housing 1301 could be coated with the high magnetic permeability material 1302 as well.

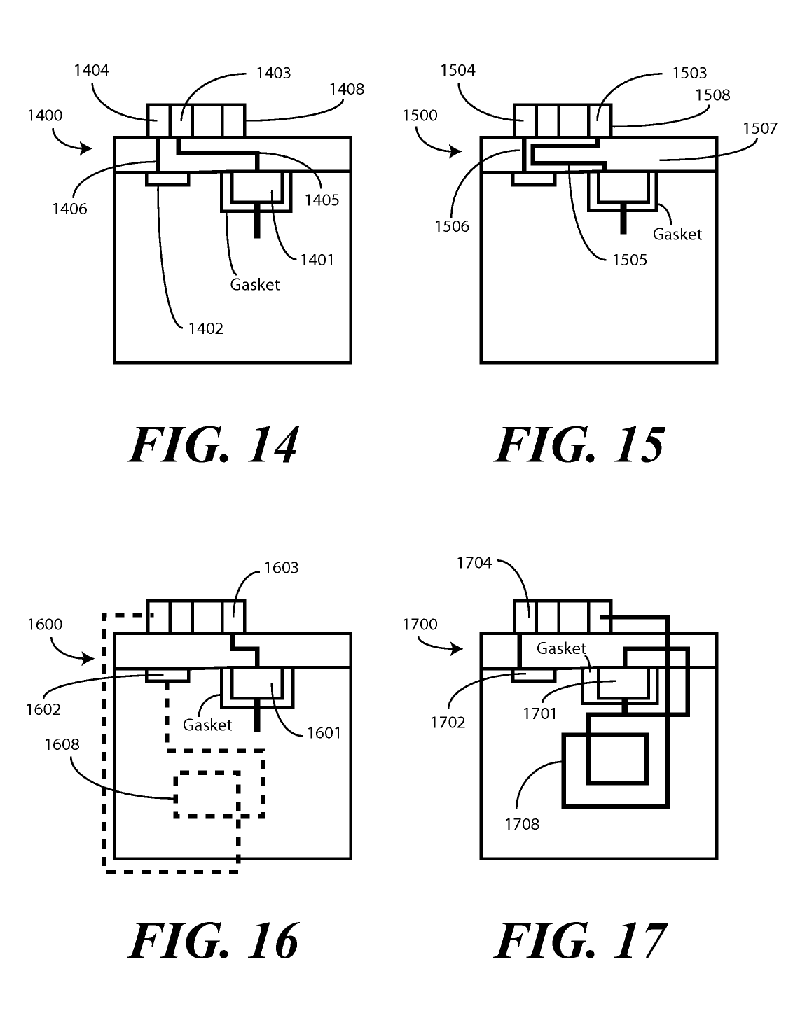

Turning now to FIGS. 14-17, illustrated therein are embodiments of battery component constructions that are configured to further reduce the emitted magnetic field noise. To this point, embodiments of the invention have focused on cell constructions and the incorporation of high magnetic permeability materials. The embodiments of FIGS. 14-17 turn the attention to the design of conductive traces that run from the contacts on the header of the cell to the contact blocks disposed externally with respect to the overall battery pack.

Beginning with FIG. 14, illustrated therein is a battery pack 1400 having an anode contact 1401 and a cathode contact 1402 disposed along a header in within the battery pack 1400. Recall from the discussion of FIG. 7 above that in some embodiments a predetermined distance (710) between the anode contact 1401 and cathode contact 1402 is required. To help mitigate emission of magnetic field noise in such a configuration, the negative terminal 1403 and positive terminal 1404 of the contact block 1408 have been placed closely together. This placement works to minimize the area of any current loops created by conductors 1405,1406, which run from the anode contact 1401 to the negative terminal 1403 and from the cathode contact 1402 to the positive terminal 1404, respectively. The minimization of loops works to minimize the external magnetic field emitted by the battery pack 1400.

Turning now to FIG. 15, illustrated therein is another battery pack 1500 configured in accordance with embodiments of the present invention. In FIG. 15, due to design constraints, the negative terminal 1503 and positive terminal 1504 cannot be placed in an adjacent relationship along the contact block 1508. This can occur when the electronic device to which the battery pack 1500 is coupled requires such a contact block configuration.

To mitigate emitted magnetic field noise in such a situation, in one embodiment of the invention the conductor 1505 from one polarity of the cell can be routed across the header 1507 in a partial loop or coil so as to be closer to the conductor 1506 of the second polarity. This routing works to reduce any included area of resulting current loops, thereby reducing the externally emitted magnetic fields. Each conductor 1505,1506 serves as an electrical conductor coupling the negative terminal 1503 and positive terminal 1504, which are conductive surfaces disposed along the housing, to the electrochemically active layers and current collector layers within the cell.

Turning now to FIGS. 16 and 17, illustrated therein are additional battery packs 1600,1700 configured in accordance with embodiments of the present invention. In FIGS. 16 and 17, a coil 1608,1708, which comprises one or more turns of conductive material, is optimally placed on or around the cell to further reduce the magnetic field noise. Each coil 1608,1708 is arranged within or on the housing such that magnetic fields generated within combinations of the electrochemically active layer, the current collector layer, and the electrical conductors are reduced during discharge of the battery pack.

The coils 1608,1708 are connected in series with either the cathode contact 1602,1702 or the anode contact 1601,1701. Each coil 1608,1708 can be optimized by design of the shape, placement, and number of turns such that magnetic fields emitted by each cell are nearly totally canceled. Alternatively, the shape of the coils 1608,1708 can be designed to cancel the emitted magnetic fields in a specific area targeted by the designer away from the battery, such as near an earpiece speaker where a hearing aid may be attempting to operate, if canceling the magnetic fields over a large area is not feasible.

In one embodiment, the coils 1608,1708 are disposed along the housings of each battery pack 1600,1700. The type of housing can work to determine whether the coil 1608,1708 is connected to the anode contact 1601,1701 or the cathode contact 1602,1702. Where the housing is made from steel, the housing will generally be isolated from the positive terminal 1704. Accordingly, where the coil 1708 is disposed along the housing, the coil should be coupled to the anode contact 1701. Where the housing is made from aluminum, the housing will generally be isolated from the negative terminal 1603. Accordingly, where the coil 1608 is disposed along the housing, the coil should be coupled to the cathode contact 1602.

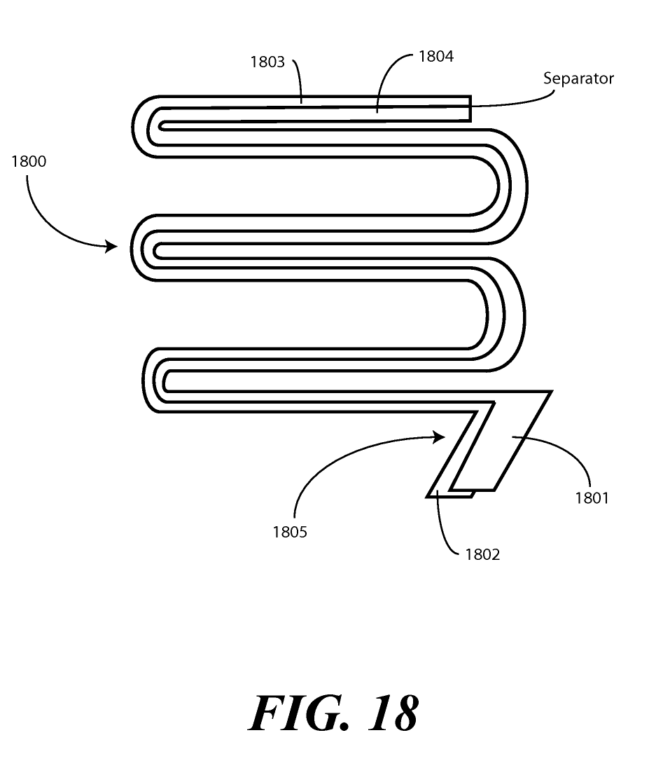

To this point, embodiments of the invention have been directed—for illustration purposes—to electrode-separator-electrode stacks that are configured in a jellyroll construct. However, it will be obvious to those of ordinary skill in the art having the benefit of this disclosure that embodiments of the invention are not so limited. For example, turning now to FIG. 18, illustrated therein is a folded construct configured in accordance with embodiments of the invention.

In FIG. 18, rather than being configured in a jellyroll, the cell 1800 is configured in a folded configuration. Despite being configured in a folded configuration, the tabs 1801,1802 are coupled to the anode 1803 and cathode 1804 at the same end 1805 of the cell. While shown side-by-side for illustration purposes, in one embodiment the tabs 1801,1802 are disposed exactly atop each other to mitigate magnetic field noise. In the case where, for one reason or another, the tabs 1801 and 1802 cannot be placed right over one another, placing then close to one another—with a slight spacing therebetween—can be effective as well.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electrode assembly for a battery, the electrode assembly comprising:
a cell stack comprising a cathode and an anode with a separator therebetween, the cell stack having a first end and a second end;
a first electrical conductor coupled to the anode at the first end of the cell stack; and
a second electrical conductor coupled to the cathode at the first end of the cell stack;
wherein during discharge, current passes through the first electrical conductor and second conductor, and across the cathode and the anode, in substantially opposite directions at a substantially similar magnitude so as to reduce magnetic field noise generated by the electrode assembly.

2. The electrode assembly of claim 1, wherein the first electrical conductor and the second electrical conductor are disposed atop each other at the first end, the electrode assembly further comprising an electrical insulation layer disposed between the first electrical conductor and the second electrical conductor.

3. The electrode assembly of claim 1, wherein the cell stack is wound into a jellyroll.

4. The electrode assembly of claim 1, wherein the cell stack is folded.

5. The electrode assembly of claim 1, further comprising:
a third electrical conductor coupled to the anode at the second end of the cell stack; and
a fourth electrical conductor coupled to the cathode at the second end of the cell stack;
wherein the electrode assembly is configured such that a first current flowing in the anode during discharge is substantially opposite a second current flowing in the cathode at substantially similar magnitudes.

6. The electrode assembly of claim 5, further comprising a housing, wherein:
the electrode assembly is disposed within the housing;
the first electrical conductor and the third electrical conductor are coupled together within the housing by a first bridge connector; and
the second electrical conductor and the fourth electrical conductor are coupled together within the housing by a second bridge connector.

7. The electrode assembly of claim 6, wherein the first bridge connector and the second bridge connector are disposed atop each other with an electrically insulating layer therebetween.

8. The electrode assembly of claim 6, further comprising:
a fifth electrical conductor coupled to the first bridge connector and the anode between the first end of the cell stack and the second end of the cell stack; and
a sixth electrical conductor coupled to the second bridge connector and the cathode between the first end of the cell stack and the second end of the cell stack.

9. The electrode assembly of claim 1, further comprising a housing into which the electrode assembly is disposed and a header having at least a first electrical contact coupled to the anode and a second electrical contact coupled to the cathode.

10. The electrode assembly of claim 9, further comprising one or more conductor turns disposed between one or more of the anode and the first electrical contact or the cathode and the second electrical contact, the one or more conductor turns being configured to further reduce the magnetic field noise.

11. The electrode assembly of claim 10, wherein the one or more conductor turns are disposed along the header.

12. The electrode assembly of claim 10, wherein the one or more conductor turns are disposed along the housing.

13. The electrode assembly of claim 9, wherein the housing is coated with a high magnetic permeability material.

14. The electrode assembly of claim 1, wherein one or more of the anode or the cathode is impregnated with a high magnetic permeability material.

15. The electrode assembly of claim 1, wherein one or more of the anode or the cathode is coated with a high magnetic permeability material.

16. A battery pack, comprising:
an anode;
a cathode;
a separator disposed between the anode and the cathode; and
electrical conductors coupling terminals disposed outside the battery pack to the anode and the cathode, respectively;
wherein the electrical conductors are arranged within the battery pack such that magnetic fields generated within the battery pack by combinations of the anode, the cathode, and the electrical conductors are reduced during discharge of the battery pack by causing currents in the anode and the cathode to flow in opposite direction at substantially similar magnitudes.

17. The battery pack of claim 16, wherein the cathode, the anode, and the separator are arranged in a stack, wherein the electrical conductors are coupled to the anode and the cathode, respectively, at one end of the stack.

18. The battery pack of claim 17, further comprising additional electrical conductors coupled to the anode and the cathode at another end of the stack, thereby configuring the stack such that the currents flowing the anode and the cathode at each end of the stack are substantially opposite in direction and substantially equivalent in magnitude.

19. The battery pack of claim 17, wherein one or more of a housing of the battery pack, the anode or the cathode, or the electrical conductors comprises high magnetic permeability material disposed therein or thereon.

20. The battery pack of claim 17, further comprising one or more turns of electrical conductor material disposed between the stack and the terminals.
